(19) United States
(12) Patent Application Publication
(10) Pub. No.: US 2016/0063646 A1
(43) Pub. Date: Mar. 3, 2016

(54) System and Method for Controlling Access to Member Content in a Dating Website

(71) Applicant: Katarzyna Myhan, Houston, TX (US)

(72) Inventor: Katarzyna Myhan, Houston, TX (US)

(21) Appl. No.: 14/468,335

(22) Filed: Aug. 26, 2014

(51) Int. Cl. G06Q 50/00; G06Q 30/02; G06Q 20/12; H04L 29/08; G06Q 30/06

(52) U.S. Cl. CPC G06Q 50/01; H04L 67/306; G06Q 30/0601; G06Q 20/123; G06Q 30/0226

(57) ABSTRACT

The dating website disclosed can comprise a server memory and a server processor. The server memory can store a dating website and a plurality of profiles. The profiles can comprise standard profile data, premium profile data having purchasable content and non-purchasable content, and a permission status. The server processor can, according to instructions from the dating website provide access to the standard profile data within the profiles of the dating website. The server processor can further offer for sale access to each of the purchasable content, each of the purchasable content comprising a content identifier. The processor can store the content identifier on the permission status of a purchaser's profile when the member buys the purchasable content of a second member. The server processor can provide access to the purchasable content associated with the content identifier within the permission status to the member associated with the permission status.

### BACKGROUND

This disclosure relates to a system and method for a dating website.

System for providing an online dating website, have evolved over the years. Most dating websites provide free registration that allows user to browse and view other limited or exemplary user data for free. In such websites, users are usually offered access to complete actual profiles for a flat fee along with communication services. Communication services can include access to chat programs, message boards, and webcasts. In such systems, registered users can access and search for profiles of other members, as well as create a profile of their own. Thus, other registered user can freely access uploaded photos and videos of other members. In such system, a user pays for access to many profiles that are not necessarily of interest to them. Further, by giving person access to so many, it causes a user to have difficulties in making a decision.

As such it would be useful to have an improved system and method for controlling access to user content in a dating website.

### SUMMARY

A dating website system is disclosed herein. The dating website can comprise a server memory and a server processor. The server memory can store a dating website and a plurality of profiles. The profiles can comprise standard profile data, premium profile data having purchasable content and non-purchasable content, and a permission status. The server processor can, according to instructions from the dating website provide access to the standard profile data within the profiles of the dating website. The server processor can further offer for sale access to each of the purchasable content, each of the purchasable content comprising a content identifier. Additionally, the processor can store the content identifier related to the purchasable content in the permission status of a purchaser's profile when the member buys the purchasable content of a second member. Lastly, the server processor can provide access to the purchasable content associated with the content identifier within the permission status to the member associated with the permission status.

A method can include the step of providing access to a standard profile data within profiles of a dating website. An additional step can be offering for sale access to purchasable content, each purchasable content comprising a content identifier. Further, the method can provide step of storing the content identifier related to the purchasable content in a permission status of a purchaser's profile when the member buys the purchasable content of a second member. Lastly, the method can provide the step of providing access to the purchasable content associated with the content identifier within the permission status to the member associated with the permission status.

### BRIEF DESCRIPTION OF THE DRAWINGS

FIG. 1 illustrates a dating website system.

FIG. 2A illustrates a server memory within a server.

FIG. 2B illustrates profiles comprising billing information, a standard profile data, a premium profile data, and a permission status.

FIG. 3 illustrates an embodiment of a dating website comprising a user sign-up link, and a user sign in link.

FIG. 4 illustrates a main screen.

FIG. 5 illustrates a dating website displaying a profile screen of one of profile from a main screen.

FIG. 6 illustrates a dating website displaying matches of a member.

FIG. 7 illustrates a dating website displaying profiles having a purchasable content purchased by a member.

FIG. 8 illustrates an embodiment of a dating website that can be accessible through a mobile device.

FIG. 9 illustrates an exemplary method for purchasing a profile on a dating website.

FIG. 10 illustrates an embodiment of a data storage comprising one or more service provider accounts.

FIG. 11 illustrates a third party server comprising a third party website, and a third party data storage.

FIG. 12 illustrates a schematic diagram of a server according to an embodiment of the present disclosure.

### DETAILED DESCRIPTION

Described herein is an improved system and method for controlling access to user content in a dating website. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

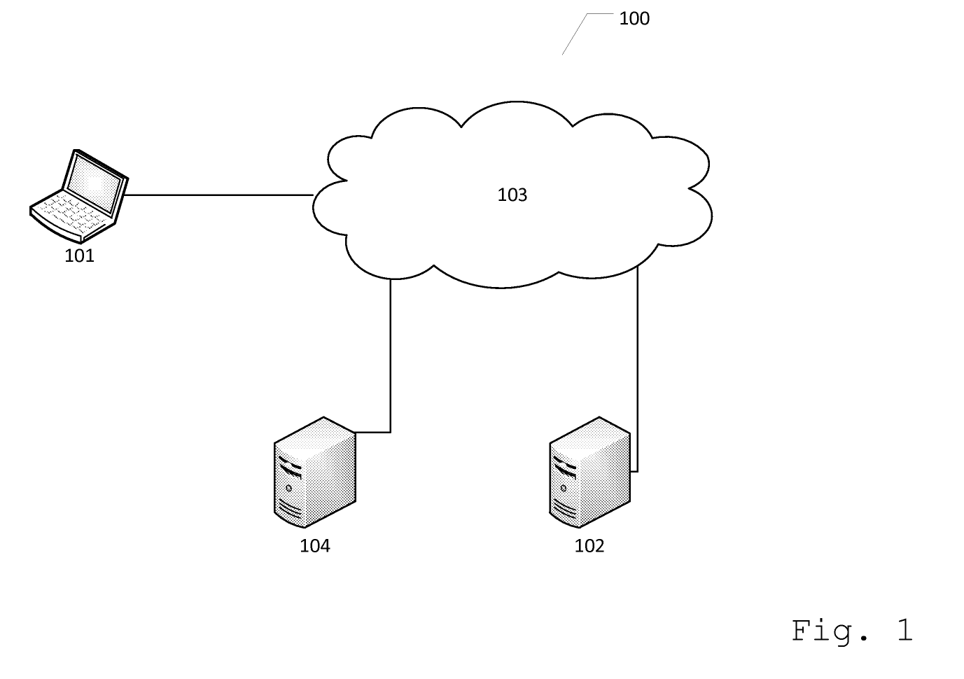

FIG. 1 illustrates a dating website system 100. Dating website system can comprise a plurality of computer 101 connected to one or more server 102 through a network 103, in one embodiment. Computers 101 can each be a desktop computer, laptop, tablet, or smartphone. Server 102 represents at least one, but can be many servers, each connected to network 103 capable of performing computational task, and storing data information. Server 102 can be accessible to an individual through a web browser providing online dating services. Network 103 can be a local area network (LAN), a wide area network (WAN), a piconet, or a combination of LANs, WANs, or piconets. One illustrative LAN is a network within a single business. One illustrative WAN is the Internet. In the preferred embodiment, network 103 will comprise the Internet. In another embodiment, dating website system 100 can further comprise one or more third party server 104. In this embodiment, dating website system 100 can allow third party server 104 an access to the services and/or contents of server 102.

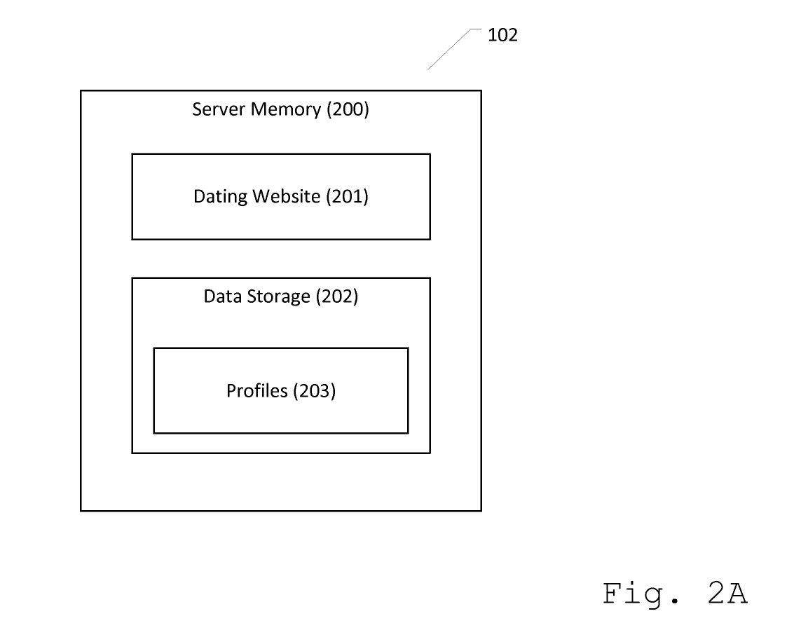

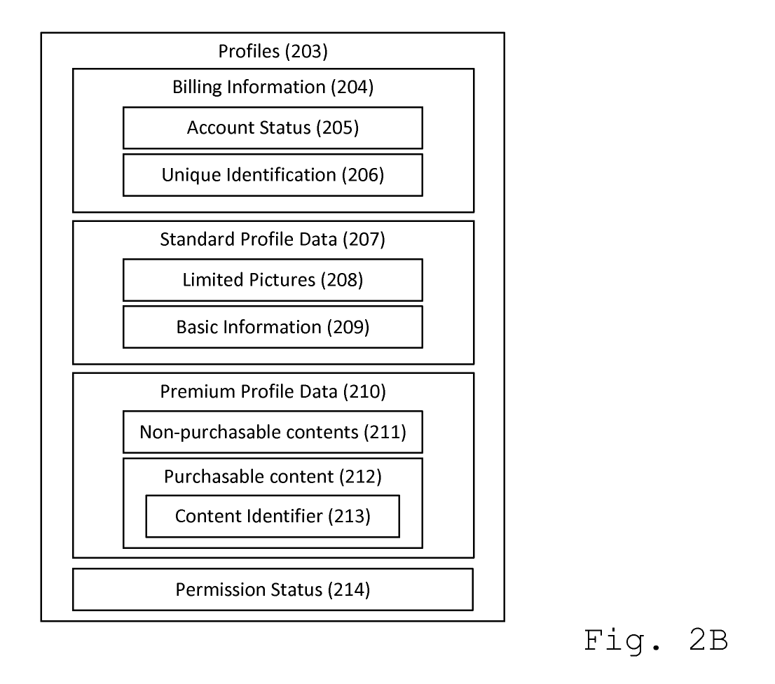

FIG. 2A illustrates a server memory 200 within server 102. Server memory 200 can comprise a dating website 201, and a data storage 202. Dating website 201 can be a program providing business logic for server 102. In this embodiment dating website 201 can contain HTML (Hyper Text Markup Language), scripts, and/or applications such as an embedded chat application. Data storage 202 can be collections of data accessible through dating website 201. Further, dating website 201 can perform functions such as adding, transferring and retrieving information on data storage 202. Data storage 202 can comprise a plurality of profiles 203. Each profile 203 can relate to a member of dating website 201.

FIG. 2B illustrates profiles 203 comprising billing information 204, a standard profile data 207, a premium profile data 210, and a permission status 214. Billing information 204 can comprise information where payment for services or goods can be charged, such as billing address, credit card details, and debit card details. Furthermore, billing information 204 can comprise an account status 205 and a unique identifier 206. Account status 205 can indicate the payment status of a registered user. Unique identifier 206 can be a unique credential that is assigned to a specific profile 203 such as a username, e-mail address, or system-assigned string.

Standard profile data 207 can comprise selected detail information that is accessible to all members of dating website 201. In one embodiment, standard profile data 207 can comprise limited pictures 208 and basic information 209. In one embodiment, limited pictures 208 can be limited by quantity or quality. Basic information 209 can be details of a user that can include but is not limited to username, age, sex, and/or location.

Premium profile data 210 can comprise non-purchasable content 211 and purchasable content 212. Non-purchasable content 211 can comprise personal data such as body characteristics, contact details, and data files that are limited and not readily accessible to members of dating website 201. Body characteristics can comprise, but are not limited to, hair color, eye color, height, weight, and/or body type. Contact details can include an email, IM username phone number, or even just a way to send a message or instant message within dating website 201. In one embodiment, all or a portion of non-purchasable content 211 can be accessible to a member once member purchases one or more purchasable content 212 within the same profile 203.

Purchasable content 212 can include but is not limited to media files such as images, videos, and audio files. Furthermore, Purchasable content 212 can be accessible to a member once that member purchases one of premium profile data 210. Each purchasable content 212 can be purchased separately. Purchasable content 212 can comprise a content identifier 213. Content identifier 213 can be a unique key assigned to each purchasable content 206.

In one embodiment, permission status 214 can comprise content identifiers 213 of other member's purchasable content 212. In such embodiment, member can access any purchasable content 212 related to each content identifier 213 within his or her permission status 214.

In one embodiment, each member can access all or a portion of a member's non-purchasable content 211 by having in his permission status 214 one or more content identifiers 213 related to purchasable content 212 in the same profile 203 as non-purchasable content 211. Therefore, if the user member desires to view non-purchasable content 211 regarding the purchaser's profile, the user member can buy purchasable content 212 related to profile 203.

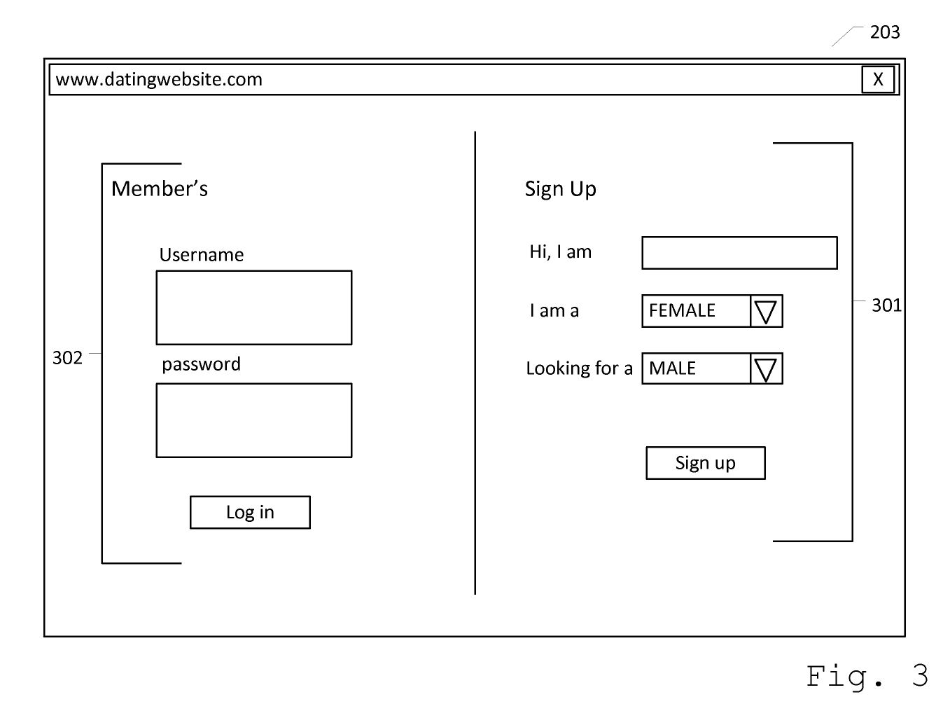

FIG. 3 illustrates an embodiment of dating website 201 comprising a user sign-up link 301, and a user sign in link 302. User sign up link 301 and user login link 302 can each be displayed as a link or a button. User sign up link 301 can allow an individual to be registered as a member of dating website 201. Moreover, registering on dating website 201 requires the member to supply unique credentials such as username, e-mail address, and password. As such, registering as a member on dating website 201 relates to creating profile 203 on data storage 202. User login link 302 can allow registered users to enter registered credentials to access dating website 201.

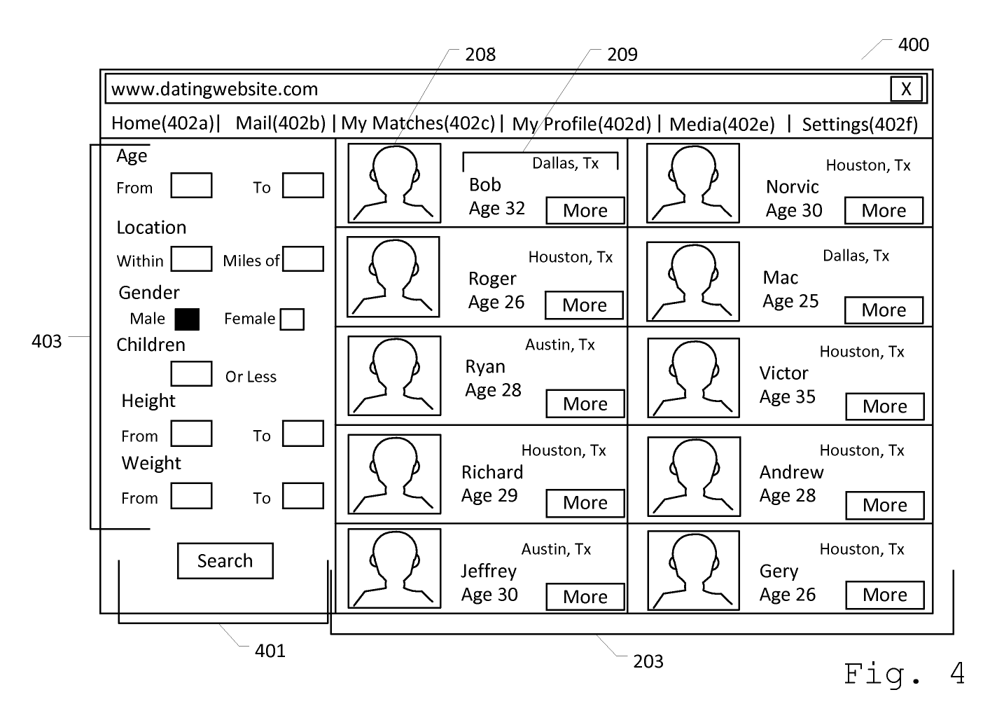

FIG. 4 illustrates a main screen 400. After a registered user signs in on dating website 201, main screen 400 can be displayed. Main screen 400 can comprise a search section 401, list of profiles 203, and a menu 402. Search section 401 can comprise a plurality of parameters 403 that can include but are not limited to age, and location. Parameters 403 can be basic information 209 that is related to profile 203. In one embodiment, a member at main screen 400 can find other members with specific qualities by entering parameters 403 on search section 401. Search section 401 can provide filtered search results of profiles 203 according to parameters 403 entered on parameters 403. In another embodiment, lists of each profile 203 can also be displayed on main screen 400. In one embodiment, each profile 203 displayed on main screen 400 can comprise limited pictures 208 and a portion of basic information 209. In this embodiment, limited pictures 208 can be displayed as a photo thumbnail.

Menu 402 can allow user to easily access common tools and links that are used in dating website 201. In one embodiment, menu 402 can be a section that is permanently displayed at a portion of dating website 201 after the user logs in. Further, menu 402 can comprise links to one or more pages. Examples of pages can include, but are not limited to, a home page 402a, a mail page 402b, a my matches page 402c, a my profile page 402d, a media page 402e, and a settings page 402f. Home menu 402a when clicked can allow user to go back to main screen 400. Mail page 402b can allow a user to access messages that are sent by other registered members.

My matches page 402c can allow a user to access the list of profiles 203 that he or she purchased and profiles 203 of other members that bought his profile. My profile page 402d can allow a member to view, and manage how his own profile screen can appear when viewed by other members. Media page 402e can allow a member to quickly access his own premium profile data 210. Settings menu 402f can also allow a member to manage his own account information, and billing information 204, in one embodiment.

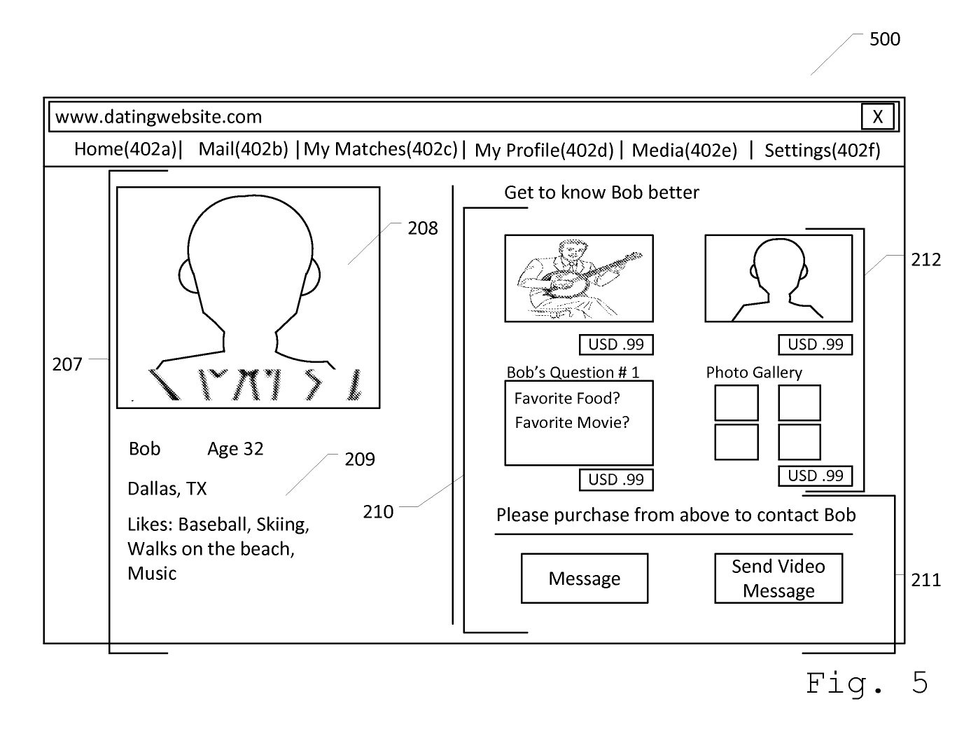

FIG. 5 illustrates dating website 201 displaying a profile screen 500 of one of profile 203 from main screen 400. Page can open to profile screen 500 once a first member clicks profile 203 of a second member. Profile screen 500 can display standard profile data 207, such as limited pictures 208 and basic information 209, and premium profile data 210 or links to obtain premium profile data 210. In one scenario, a member interested in communicating with another member can buy purchasable content 212 displayed on profile screen 500. Once payment is made for at least one of purchasable contents 212, the member can have the permission to access all or part of non-purchasable content 211. Moreover, the member can also be permitted to view purchasable content 212 that she purchased. Non-purchasable content 211 can include communication channels such as emails, instant messaging account, and contact numbers, in one embodiment. In another embodiment, non-purchasable content 211 can comprise an embedded messaging program such as a chat application, or email application that can only be accessible to members of dating website 201. Non-purchasable content can also include additional photos, additional biographical information, or other media. A designer of website 201 can decide which content can be standard profile data 207, non-purchasable content 211, and purchasable content 212. In one embodiment, when a first member purchases purchasable content 212 of a second member, the second member can have access to non-purchasable content 211 of the first member. In one embodiment, the second member can also receive a credit to buy purchasable content 212 of said first member. Alternatively, dating website 201 can instead give second member access to one or more purchasable content 212 of first member.

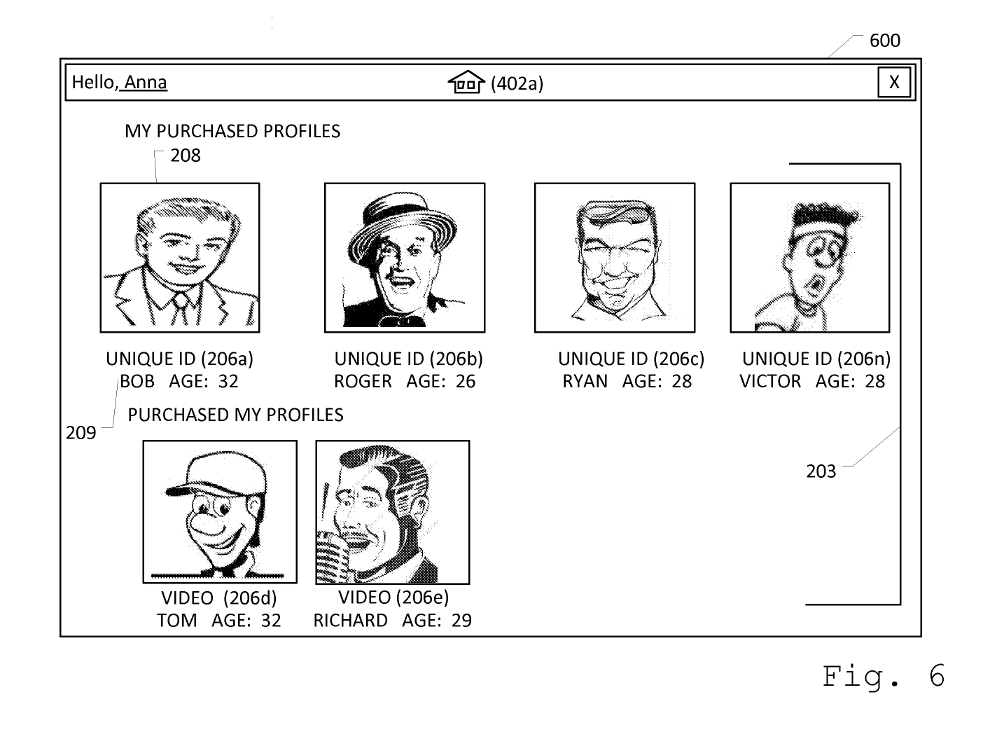

FIG. 6 illustrates dating website 201 displaying matches of a member. Once a first member buys purchasable content 212 of a second member, profile 203 of second member can appear on a display 600. As shown, website 201 can list and display profiles 203 related to purchasable content 212, as well as profiles 203 of other members who purchased the content of the first member. Each profile 203 within this section can be represented with standard profile data 207 such as limited picture 208, and/or basic information 209, in one embodiment. In another embodiment, each profile 203 can be represented with unique identifier 206, such as username. As an example scenario, once the first member buys at least one purchasable content 212 of the second member, profile 203 of the second member can appear within display 600 provided to first member by website 201. As such, dating website 201 can provide member a link to the list of other members who the member bought purchasable content 212 from, and the list of members that purchased premium profile data 210 of member.

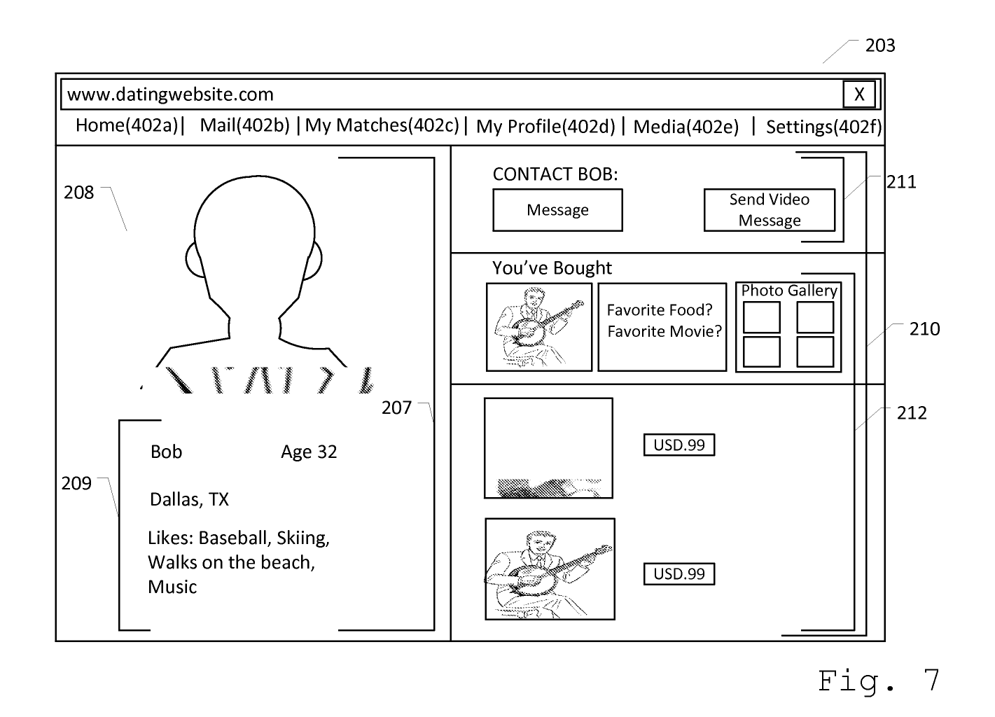

FIG. 7 illustrates dating website 201 displaying profiles 203 having purchasable content purchased by member. Website 201 can display the second member's standard profile data 207, premium profile data 210, and other purchasable contents 212 that were not yet purchased by first member. In such scenario, the first member can view purchasable contents 212 of the second member that the first member bought, as well as non-purchasable content 211 of the second member. The first member can also browse through and choose to buy unpurchased purchasable contents 212 of the second member.

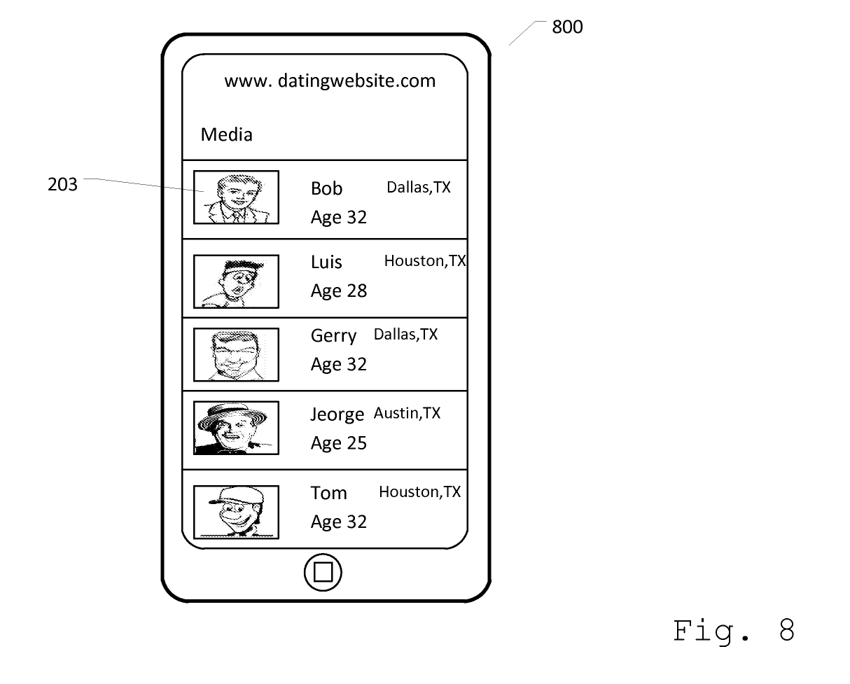

FIG. 8 illustrates an embodiment of dating website 201 that can be accessible through a mobile device 800. By mobile device 800, a member can view lists of purchasable content 212, buy purchasable content 212, and view purchased content 212 along with related profile 203. Mobile device 800 can include, but is not limited, to a mobile phone, a personal digital assistant (PDA), and/or tablet.

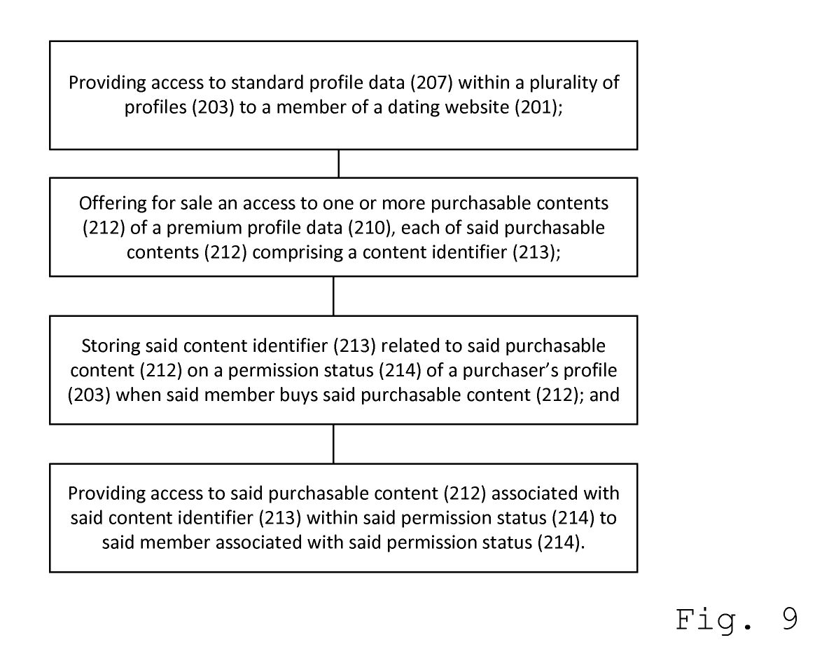

FIG. 9 illustrates an exemplary method for purchasing profile 203 on a dating website 201. A user can register or sign up on dating website 201 to access profiles 203. After successfully registering and logging into dating website 201, screen can display main screen 400. Main screen 400 can provide an access to other members of dating website 201. In one embodiment, the member can search for a specific user member through search section 401. In another embodiment, the account member can select a user member from the list of profiles 203 displayed on main screen 400. The account member can click on profile 203 to view more information regarding a certain user member.

As an example scenario, a first member can click on profile 203 of a second member to view the second member's information. Therefore dating website 201 can display the second member's standard profile data 207 and premium profile data 210. Premium profile data 210 can comprise non-purchasable content 211 and purchasable content 212 of the user member. The first member can then purchase at least one of purchasable content 212 of the second member to access the second member's non-purchasable content 211.

Once the first member purchases at least one of second member's purchasable contents 212, a server processor can store a content identifier 213 assigned to purchasable content 212 of second member and store content identifier 213 on permission status 214 of the first member. Furthermore, since payment is made on purchasable content 212 of second member, non-purchasable content 211 of second member can now be accessible to first member.

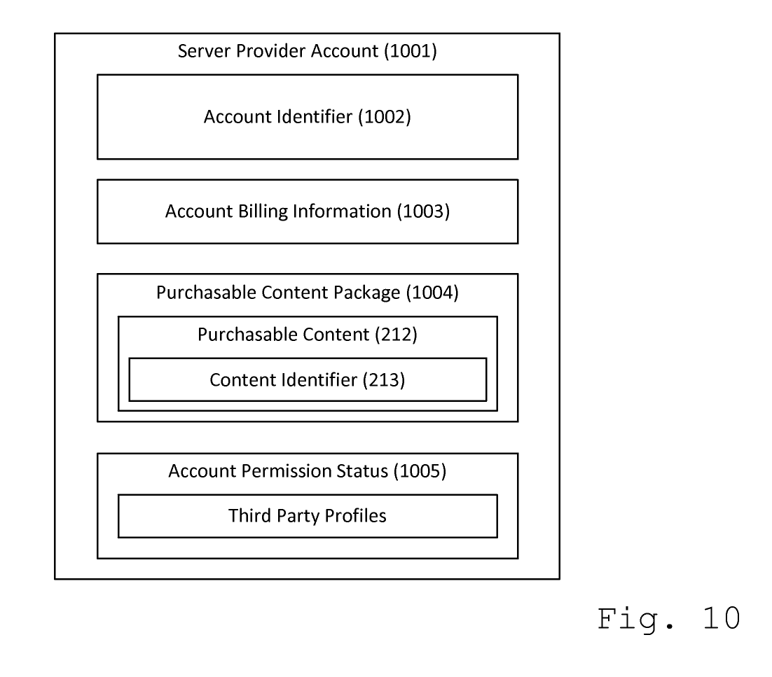

FIG. 10 illustrates an embodiment of data storage 202 comprising one or more service provider accounts 1001. In an embodiment wherein dating website system further comprises third party server 104, data storage 202 can comprise one or more service provider accounts 1001. Each service provider account 1001 can be related to a third party dating website service provider. Service provider account 1001 can comprise an account identifier 1002, account billing information 1003, one or more purchasable content packages 1004, and an account permission status 1005. Account identifier 1002 can be a unique identification assigned to each third party dating website. In a preferred embodiment, billing information of third party dating website service provider such as billing address, bank draft information, credit card details, and debit card details can be stored on account billing information 1003. Purchasable content packages 1004 can comprise purchasable content 212. Purchasable content 201 can comprise one or more content identifiers 213. In one embodiment, account permission status 1005 can comprise a list of third party profiles having permission to access specific purchasable contents 212.

In one scenario, third party dating website service provider can create an account on dating website 201 and information can be stored under service provider account 1001. This can allow third party dating website service provider to access purchasable content package 1004. As such, members of third party dating website service provider can access, create, store, and buy purchasable contents 212 on service provider account 1001.

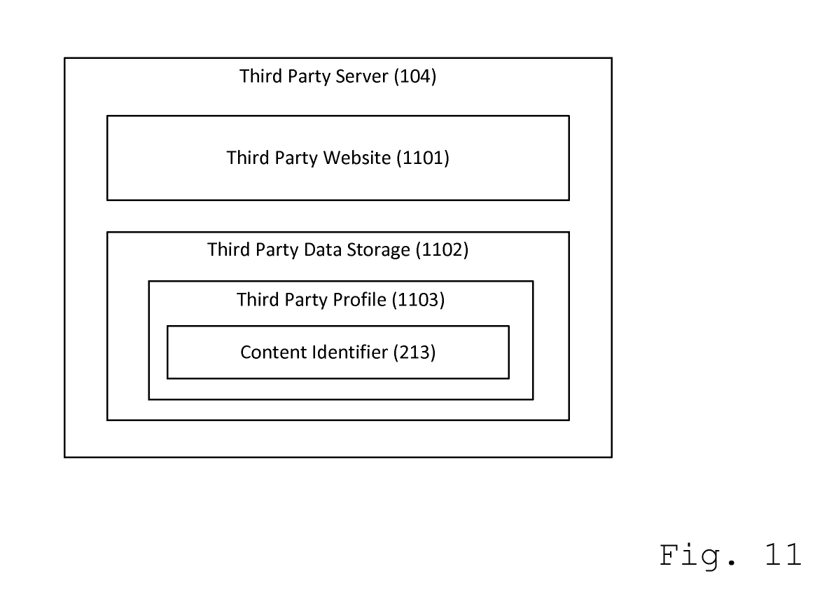

FIG. 11 illustrates third party server 104 comprising a third party website 1101, and a third party data storage 1102. Third party website 1101 can be related to a website that provides dating services. Third party data storage 1102 can comprise one or more third party profiles 1103. Third party profiles 1103 can be related to members of third party website 1101. Third party profiles 1103 can comprise content identifier 213.

In an example scenario, a first member of third party website 1101 can create and upload purchasable content 212 using third party website 1101. In this embodiment, third party website 1101 can then communicate with server 102 and store purchasable content 212 under purchasable content packages 1004 of service provider account 1001. Uploaded purchasable content 212 that is associated with the first member can be displayed on third party website 1101 as a link, in one embodiment. In such embodiment, a second member that is interested with the first member can click the link. Clicking the link from third party website 1101 can allow second member to buy purchasable content 212 of the first member. Once payment is completed for the purchasable content 212, content identifier 213 that is assigned to purchasable content 212 can be stored on third party profile 1103 of the second member. Moreover, third party profile 1103 of the second member can be stored under account permission status 1005 of service provider account 1001. This can allow the second member to access purchasable contents 212 of each third party profiles 1103 that he purchases.

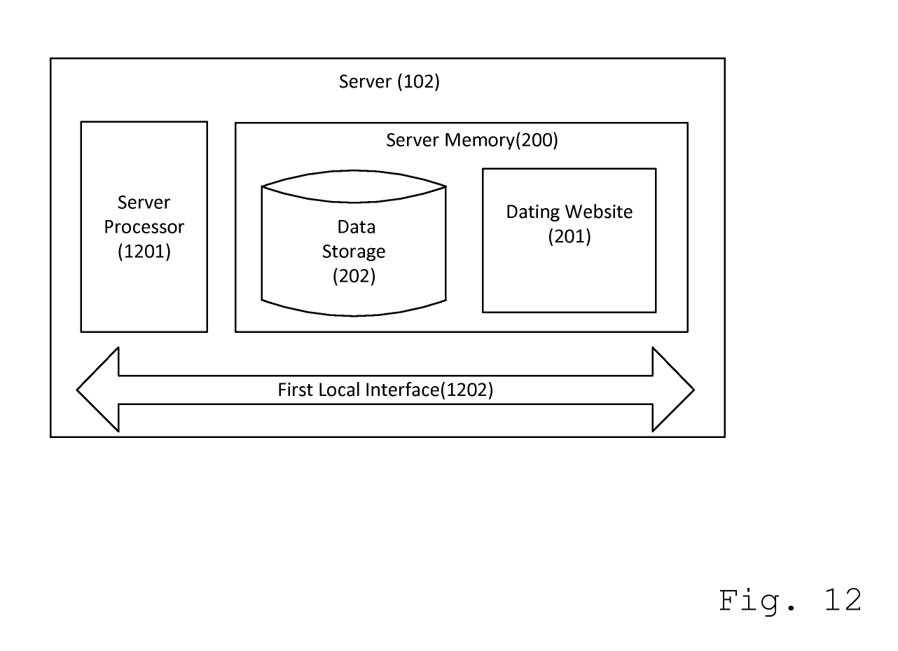

FIG. 12 illustrates a schematic diagram of server 102 according to an embodiment of the present disclosure. Server 102 can comprise a server processor 1201, and server memory 104 and a first local interface 1202. First local interface 1202 can be a program that controls a display for the user, which can allow user to view and/or interact with server 102. Server processor 1201 can be a processing unit that performs set of instructions stored within server memory 104.

Server 102 includes at least one processor circuit, for example, having server processor 201 and server memory 104, both of which are coupled to first local interface 1202. To this end, server 102 can comprise, for example, at least one server, computer or like device. Server memory can comprise dating website 201 and data storage 202. First local interface 202 can comprise, for example, a data bus with an accompanying address/control bus or other bus structure as can be appreciated.

In particular, stored in the server memory 104 and executable by server processor 1201 are dating website 201, and potentially other applications. Also stored in server memory 104 can be data storage 202 and other data. In addition, an operating system can be stored in server memory 104 and executable by server processor 1201.

It is understood that there can be other applications that are stored in server memory 104 and are executable by server processor 1201 as can be appreciated. Where any component discussed herein is implemented in the form of software, any one of a number of programming languages can be employed such as, for example, C, C++, C#, Objective C, Java, Java Script, Perl, PHP, Visual Basic, Python, Ruby, Delphi, Flash, or other programming languages.

A number of software components can be stored in server memory 104 and can be executable by server processor 1201. In this respect, the term “executable” means a program file that is in a form that can ultimately be run by server processor 1201. Examples of executable programs can be, for example, a compiled program that can be translated into machine code in a format that can be loaded into a random access portion of server memory 104 and run by server processor 1201, source code that can be expressed in proper format such as object code that is capable of being loaded into a random access portion of server memory 104 and executed by server processor 1201, or source code that can be interpreted by another executable program to generate instructions in a random access portion of provider memory 104 to be executed by server processor 1201, etc. An executable program can be stored in any portion or component of server memory 104 including, for example, random access memory (RAM), read-only memory (ROM), hard drive, solid-state drive, USB flash drive, memory card, optical disc such as compact disc (CD) or digital versatile disc (DVD), floppy disk, magnetic tape, network attached/addressable storage or other memory components.

Server memory 104 can include both volatile and non-volatile memory and data storage components. Volatile components do not retain data values upon loss of power. Non-volatile components, on the other hand, retain data upon a loss of power. Thus, server memory 104 can comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM can comprise, for example, static random access memory (SRAM), dynamic random access memory (DRAM), or magnetic random access memory (MRAM) and other such devices. The ROM can comprise, for example, a programmable read-only memory (PROM), an erasable programmable read-only memory (EPROM), an electrically erasable programmable read-only memory (EEPROM), or other like memory device.

Also, server processor 1201 can represent multiple processors. Likewise, server memory 104 can represent multiple memories that operate in parallel processing circuits, respectively. In such a case, first local interface 1202 can be an appropriate network, including network 103 that facilitates communication between any two of the multiple server processors 1201, between any server processor 1201 and any of the server memory 104, or between any two of the server memory 104, etc. First local interface 1202 can comprise additional systems designed to coordinate this communication, including, but not limited to, performing load balancing. Server processor 1201 can be of electrical or of some other available construction.

Although dating website 201, and other various systems described herein can be embodied in software or code executed by general purpose hardware discussed above, dating website 201 can also be embodied in dedicated hardware or a combination of software/general purpose hardware and dedicated hardware. If embodied in dedicated hardware, each dating website 201 can be implemented as a circuit or state machine that employs a number of technologies. These technologies can include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowchart of FIG. 9 shows the functionality and operation of an implementation of portions of dating website 201. If embodied in software, each block can represent a module, segment, or portion of code that comprises program instructions to implement the specified logical function(s). The program instructions can be embodied in the form of source code that comprises human-readable statements written in a programming language or machine code that comprises numerical instructions recognizable by a suitable execution system such as server processor 201 in a computer system or other system. The machine code can be converted from the source code, etc. If embodied in hardware, each block can represent a circuit or a number of interconnected circuits to implement the specified logical function(s).

Although the flowchart of 9 show a specific order of execution, the order of execution can differ from what is depicted. For example, the order of execution of two or more blocks can be rearranged relative to the order shown. Also, two or more blocks shown in succession in flowchart 9 can be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. All such variations are within the scope of the present disclosure.

Also, any logic or application described herein that comprises software or code, including dating website 201, can be embodied in any computer-readable storage medium for use by or in connection with an instruction execution system such as, server processor 1201 in a computer system or other system. The logic can comprise statements including instructions and declarations that can be fetched from the computer-readable storage medium and executed by the instruction execution system.

In the context of the present disclosure, a “computer-readable storage medium” can be any medium that can contain, store, or maintain the logic or application described herein for use by or in connection with the instruction execution system. The computer-readable storage medium can comprise any one of many physical media, such as electronic, magnetic, optical, electromagnetic, infrared, or semiconductor media. More specific examples of a suitable computer-readable storage medium can include, but are not limited to, magnetic tapes, magnetic floppy diskettes, magnetic hard drives, memory cards, solid-state drives, USB flash drives, or optical discs. Also, the computer-readable storage medium can be a random access memory (RAM), including static random access memory (SRAM), dynamic random access memory (DRAM) or magnetic random access memory (MRAM). In addition, the computer-readable storage medium can be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A dating website comprising
a server memory that stores
a dating website; and
a plurality of profiles, each of said profiles comprises
a standard profile data;
a premium profile data comprising purchasable content and non-purchasable content; and
a permission status; and
a server processor that, according to instructions from said dating website
provides access to said standard profile data within said plurality of profiles to a member of said dating website;
offers for sale access to each of said purchasable contents, each of said purchasable contents comprising a content identifier; and
stores said content identifier related to said purchasable content on said permission status of a purchaser's profile when said member buys said purchasable content of a second member; and
provides access to said purchasable content associated with said content identifier within said permission status to said member associated with said permission status.

2. The system of claim 1 wherein said non-purchasable content of said member is accessible to said second member when said first member buys said purchasable content of said second member.

3. The system of claim 2 wherein said second member receives a credit to buy one or more purchasable contents of said first member.

4. The system of claim 1 wherein said purchasable content comprises a video file.

5. The system of claim 1 wherein said purchasable content comprises an audio file.

6. The system of claim 1 wherein said non-purchasable content can comprise an embedded messaging program.

7. A method for controlling access to member content in a dating website comprising the steps
providing access to standard profile data within a plurality of profiles to a member of a dating website;
offering for sale an access to one or more purchasable contents of a premium profile data, each of said purchasable contents comprising a content identifier;
storing said content identifier related to said purchasable content on a permission status of a purchaser's profile when said member buys said purchasable content; and
providing access to said purchasable content associated with said content identifier within said permission status to said member associated with said permission status.

8. The method of claim 7, prior to storing said content identifier on said permission status comprises the step of purchasing at least one of said purchasable contents of a second member by a first member.

9. The method of claim 8, further comprising the step of providing access to said second member to said non-purchasable content of said first member.

10. The method of claim 9, further comprising the step of offering a credit to said second member for said purchasable content of said first member.

11. The method of claim 7 wherein said purchasable content comprises a video file.

12. The method of claim 7 wherein said purchasable content comprises an audio file.

13. The method of claim 7 wherein said non-purchasable content can comprise an embedded messaging program.

14. A non-transitory computer readable storage medium having a computer readable program code embodied therein, wherein the computer readable program code is adapted to be executed to implement the method of claim 1.
